(19) United States
(12) Patent Application Publication
(10) Pub. No.: US 2024/0280444 A1
(43) Pub. Date: Aug. 22, 2024

(54) FLUID SAMPLING METHOD AND APPARATUS

(71) Applicants: Kimberly Lynn Kanapeckas Metris, Clemson, SC (US); Jeremy Michel Metris, Clemson, SC (US)

(72) Inventors: Kimberly Lynn Kanapeckas Metris, Clemson, SC (US); Jeremy Michel Metris, Clemson, SC (US)

(21) Appl. No.: 18/112,595

(22) Filed: Feb. 22, 2023

(51) Int. Cl. G01N 1/22

(52) U.S. Cl. CPC G01N 1/2273; G01N 1/2205; G01N 2001/2279; G01N 2001/2285

(57) ABSTRACT

A fluid sampling process and apparatus for maintaining initial sterile conditions so as to reduce or eliminate contaminants in a collected sample and for preventing sample loss.

### BACKGROUND OF THE INVENTION

This invention relates generally to the art of sampling and more particularly to the art of fluid sampling while maintaining initial sterile conditions and preventing sample loss and contamination. Generally, the prior art related to this application is described in a NASA publication “Airborne Bacteria in Earth's Lower Stratosphere Resemble Taxa Detected in the Troposphere” August 2018 volume 9 article 1752.

As disclosed therein air samples are received and filtered to collect samples on a filtration device. While the method and apparatus described therein function as intended there is room for improvement in the collection process and the apparatus used therein.

### SUMMARY OF THE INVENTION

It is an object of this invention to provide a fluid sampling process and apparatus for maintaining initial sterile conditions so as to reduce or eliminate contaminants in the collected sample and for preventing sample loss.

These as well as other objects are achieved utilizing a sampling probe featuring a mast with port inlets and a valved inline sterile isolation chamber in conjunction with a vacuum pump and manifold to control a fluid volume through said probe. All fluid flowing through the probe is sampled. A sleeve covers the mast static port inlets during handling before and after sampling for added protection.

### BRIEF DESCRIPTION OF THE DRAWINGS

FIG. 1 schematically depicts the process and apparatus of this invention.

FIG. 2 is a plan view of the apparatus of this invention in use.

### DETAILED DESCRIPTIONS

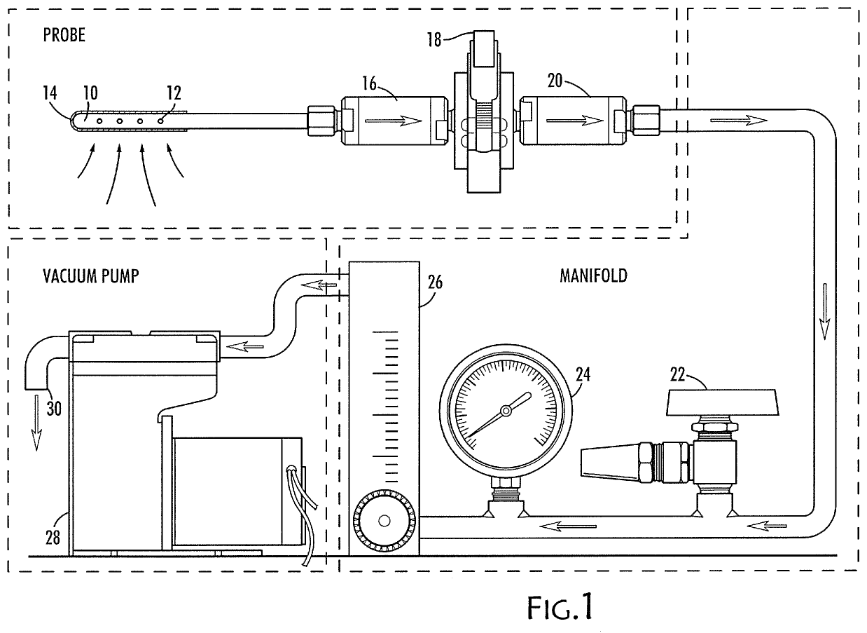

FIG. 1 of the drawings illustrates schematically the sampling apparatus of this invention. The apparatus features three sub-assemblies: (i) a mast with static port inlets, intake valve, filter isolation chamber and discharge valve (hereafter the “probe”); (b) flow meter, vacuum gauge, vacuum release valve and muffler (hereafter the “manifold”); and (c) vacuum pump and electric power source. A sampling probe comprised of a mast with ports, intake valve, isolation chamber and discharge valve therein is utilized to collect sampled material from a fluid to be further described infra.

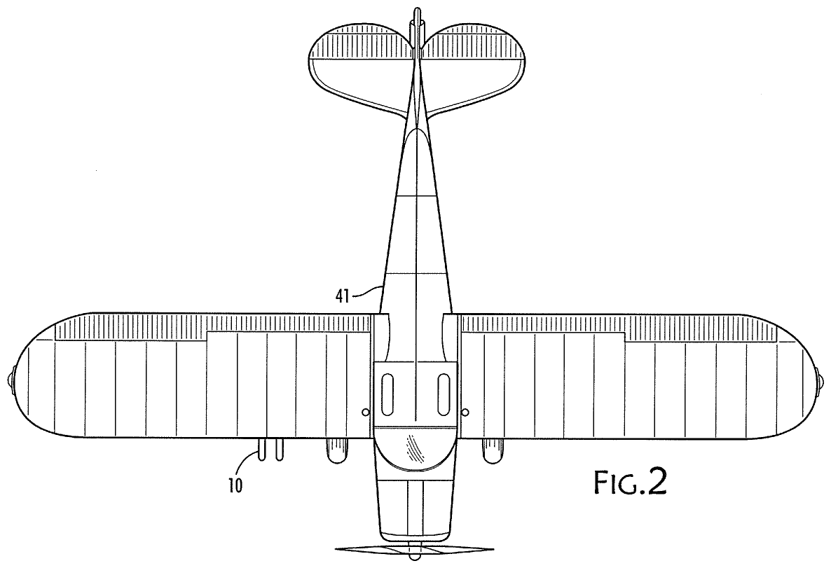

A sleeve 14 covers the mast 10 so as to maintain sterile conditions therein just before use and to protect the sample from loss or contamination after use. The sampling mast is in fluid communication with an intake valve 16, an isolation chamber 18 having situated therein a sampling means such as a membrane filter to collect samples contained in the fluid passing through. The isolation chamber 18 is in communication with a discharge valve 20, a vacuum release valve 22, a vacuum gauge 24, a flow meter 26, and a vacuum pump 28 which discharges the fluid to the ambient environment at 30. Typically, the sampling probe is mounted on a sampling vehicle such as airplane 41 illustrated in FIG. 2 of the drawings.

The apparatus of this invention incorporates the probe to capture environmental nucleic acids or other particulate matter from the fluid, gas or liquid, such as atmospheric gas, water body, etc. by circulating and filtering such fluid through a sterile membrane housed inside a valved inline sterile isolation chamber 18.

The principal features of the probe are the intake valve and discharge valve on the respective inlet and outlet of the isolation chamber which by default are always closed thus ensuring initial sterility of the collection medium or membrane filter before sampling and preventing loss or contamination of the collected material after sampling.

All probe components withstand standard sterilization processes. Once the sampling probe has been sterilized, loaded with a sterile collection medium, assembled, and fastened in a biosafety cabinet or other controlled environment with its protective sleeve placed on the mast, the probe can be transported and deployed (e.g., on an aircraft wing) to sample the fluid environment.

Sampling is initiated by turning on the vacuum pump and closing the vacuum release valve thus generating differential pressure by air pumping action or vacuum downstream of the probe which draws the fluid through the mast static port inlets through the intake valve through the isolation chamber where the membrane filter collects the sampled material through the discharge valve through the instrumentation on the manifold and through the vacuum pump as described above.

Sampling is stopped by turning off the vacuum pump and opening the vacuum release valve thus removing the differential pressure downstream of the probe, stopping the fluid flow, and closing the intake valve and discharge valve thereby isolating the collected sample within the isolation chamber.

In a controlled environment such as a biological safety cabinet the collected sample is removed from the isolation chamber using sterile forceps and processed for analysis.

Having generally described the invention the metes and bounds thereof are be limited only as set forth in the following appended claims.

What is claimed is:

1. A fluid sampling apparatus for sampling a body of fluid from the environment while maintaining sterile conditions before sampling and protecting the collected material from loss or contamination after sampling comprising;
a sampling probe with mast having ports for contact with the fluid;
a sleeve for covering said sampling mast and to maintain sterility thereof;
an intake valve in communication with said sampling mast for opening and closing to either permit or prevent fluid flow therethrough,
said intake valve for closing to either maintain initial sterility or to prevent loss or contamination of the collected sample,
an isolation chamber in fluid communication with said intake valve for receiving fluid from said intake valve, having an intake half and a discharge half;
a collection medium or membrane filter housed in said isolation chamber for collecting sampled material from said fluid flowing through said intake half and discharge half;
a discharge valve in fluid communication with said isolation chamber for opening and closing to either permit or prevent fluid flow there through,
said discharge valve for closing to either maintain initial sterility or to prevent sample loss or contamination in conjunction with said intake valve,
said discharge valve being in fluid communication with a source of reduced pressure for moving said fluid through said sampling probe, including through said mast and collection medium or membrane filter inside said isolation chamber, when said intake valve and discharge valve are open.

2. The apparatus according to claim 1 further including between said discharge valve and said source of reduced pressure, means for measuring pressure.

3. The apparatus according to claim 1 further comprising between said discharge valve and said source of reduced pressure, means for measuring temperature.

4. The apparatus according to claim 1 further comprising between said discharge valve and said source of reduced pressure, means for measuring humidity.

5. The apparatus according to claim 1 further comprising between said discharge valve and said source of reduced pressure, means for measuring flow.

6. A process for sampling of a fluid in initial sterile conditions and preventing loss and contamination of the sample,
Providing an apparatus comprising;
a sampling probe with mast having ports for contact with the environment;
a sleeve for covering said mast and ports and to maintain sterility thereof;
an intake valve in fluid communication with said sampling mast for opening and closing to either permit or prevent fluid flow therethrough,
said intake valve for closing to either maintain initial sterility or to prevent loss or contamination of the collected sample,
an isolation chamber in fluid communication with said intake valve for receiving fluid therefrom, having an intake half and a discharge half;
a collection medium or membrane filter housed in said isolation chamber for collecting sampled material from said fluid flowing through said intake half and said discharge half;
a discharge valve in fluid communication with said isolation chamber for opening and closing to either permit or prevent fluid flow there through,
said discharge valve for closing to either maintain initial sterility or to prevent sample loss or contamination in conjunction with said intake valve,
said discharge valve being in fluid communication with a source of reduced pressure for moving said fluid through said sampling probe, including through said mast and collection medium or membrane filter inside said isolation chamber, when said intake valve and discharge valve are open.
decontamination and sterilization of said apparatus being performed in a controlled sterile environment, the probe subsequently being loaded with a sterile collection medium or membrane filter, assembled, and fastened in said sterile environment thereafter placing said sleeve over said mast while in said sterile environment with intake valve and discharge valve closed;
transporting said apparatus from said sterile environment to a vehicle and attaching said apparatus thereto;
removing said sleeve from said mast;
exposing said apparatus to said fluid and closing the vacuum release valve with said intake valve and said discharge valve open to capture sample material on said collection medium or membrane filter while operating said source of reduced pressure;
terminating source of reduced pressure and opening said vacuum release valve with said intake valve and said discharge valve closed to prevent sample loss or contamination and replacing said sleeve over said mast;
removing said apparatus from said vehicle and placing said apparatus in said sterile environment;
removing said collection medium or membrane filter from said isolation chamber and analyzing material collected thereon.
